(19) United States
(12) Patent Application Publication
(10) Pub. No.: US 2002/0125594 A1
(43) Pub. Date: Sep. 12, 2002

(54) Method of manufacturing wood-like polyvinyl chloride boards of low density and improved properties and resulting product

(75) Inventors: Kung-Liang Kevin Sung, Victoria, TX (US); Jyh-yao Raphael Li, Parsippany, NJ (US)

Correspondence Address: KENNETH P. GLYNN, ESQ., 24 Mine Street, Flemington, NJ, 08822-1598, US

(73) Assignee: Wilderness Wisdom, Inc.

(21) Appl. No.: 09/753,428

(22) Filed: Jan. 3, 2001

(51) Int. Cl. B29C 44/24

(52) U.S. Cl. 264/40.1; 264/45.5; 264/45.9; 264/46.1; 264/68; 521/79

(57) ABSTRACT

Methods are provided in this invention to produce wood-like boards of polyvinylchloride, which are suitable for applications, such as graphic art, construction, furniture, etc. In one of the two embodiments disclosed in this invention, the wood-like polyvinyl chloride boards have smooth surface quality, a density below 0.95 g/cm3, good dimensional stability and strong abrasive resistance. These are produced by hot mixing, cold mixing, extrusion, calibration for quenching and subsequent cutting, to produce solid skin, foamed core products. In the other embodiment, the wood-like polyvinyl chloride boards have embossed surface quality, a density below 1.0 g/cm3, good dimensional stability and surface hardness. These are produced by hot mixing, cold mixing, extrusion and subsequent slow cooling with a roller system to produce embossed products.

### BACKGROUND OF THE INVENTION

1. Field of the Invention

The present invention relates to a method of manufacturing extruded thermoplastic sheeting of composite materials of mixtures of polyvinyl chloride (hereinafter preferred to as PVC) and wood particles. More particularly, it relates to foamed thermoplastic wood board product, which has low density, good dimensional stability, smooth surface quality, strong abrasive resistance, good flammability resistance, long-termed outdoor durability and wood-like features, and is suitable for applications, such as graphic art, construction, furniture, etc.

2. Information Disclosure Statement

Thermoplastic sheeting of composite materials, which consists of a mixture of wood particles and thermoplastic materials, has been known for many years. The materials so formed may be used in many of the same applications as wood products but offer the advantage of providing high resistance to rot, insects and moisture. In addition, these products can have the same workability as wood and are splinter-free.

Various types of wood-thermoplastic sheeting have been taught and patented. U.S. Pat. Nos. 5,088,910, 5,096,046, 5,096,406 and 5,759,680 disclosed a composite comprising of cellulosic fiber particles and thermoplastic polymeric material and a process for production thereof. The cellulosic fiber and polymeric component are mixed in a mixer while raising the temperature of the mixture to the encapsulation point, maintaining the encapsulated material within the encapsulation range while reducing the particle size, and thereafter the materials are extruded while controlling its temperature within the encapsulation range and substantially aligning the fibers in the flow direction until the material contacts a heated die. The extruded composite of the invention has excellent fiber encapsulation and related physical properties without relying on special lubricants, plasticizers or bonding agents. However, the teachings require extensive and uncommon equipment to create such synthetic wood products. The thermoplastic polymeric material consists essentially of polyolefins, which are highly flammable and do not have good outdoor weatherability. Flame retardant and UV stabilizer are needed for applications, which need stringent fire safety requirements and long-term outdoor exposure. In addition, the surface of the synthetic wood from the process of the teachings is rough and the density is high, which is around 0.95 g/cm3.

U.S. Pat. Nos. 5,746,958 and 5,851,469 disclosed a method for making a wood-thermoplastic composite material composed of a wood component and a thermoplastic component comprising the steps of mixing and increasing the bulk density of feedstick, forming a wood-thermoplastic thermoplastic mass at a temperature above the melting temperature of the thermoplastic component, extruding the mass through a converging die to form a profile, feeding the profile through a thermally insulated land section and quenching the profile in a non-oxidizing environment. The finished profile of the wood-thermoplastic material has a good dimensional stability. The thermoplastic polymeric material in this invention is polyethylene (hereinafter referred to as PE), which is one of the polyolefins. Therefore, the wood-thermoplastic composite is highly flammable and does not have good outdoor weatherability as the composite disclosed in U.S. Pat. No. 5,088,910 et al. The density of the wood-thermoplastic composite is also around 0.95 g/cm3. In addition, the surface of the wood-thermoplastic composite is rough since the extruded profile is quenched by direct contact with water after the exit of the thermally insulated land section.

U.S. Pat. Nos. 5,635,125 and 5,992,116 disclosed an artificial shake type shingle and the method for the production thereof. The artificial shingle is comprised of a molded composite of wood or cellulose particles and PVC particles. The production method consists of the steps of mixing the wood and PVC particles and additives in a mixer, melting and extruding the mixture in an extruder, pelletizing the extrudate into particles and injection molding the thermoplastic-wood composite to form the shingles. The thermoplastic-wood composite is capable of withstanding weathering and physical abuse from hail without breaking or splintering. Polyvinyl chloride is a thermoplastic material, which has much better flame resistance and outdoor UV resistance in comparison with polyethylene. However, the density of PVC, which is in the range of about 1.35 to about 1.45 g/cm3, is about 50% higher than that of polyethylene, which has a density in the range of about 0.92 to about 0.95 g/cm3. As a result, wood-thermoplastic composite of PVC is in general much heavier than wood thermoplastic composite of PE.

To reduce the density of PVC in order to obtain a board of light weight, a foaming agent is generally added into the forming composition. Processes of manufacturing a rigid and lightweight foam made by adding a foaming agent to PVC are disclosed in, for example, U.S. Pat. Nos. 5,102,922 and 4,904,427. The fillers of the composition are inorganic fillers such as calcium carbonate, talc, etc. It is found by the present inventors that foamed PVC boards, which contain only inorganic filler but do not contain cellulosic materials such as wood fibers in the forming composition and which are produced by the process disclosed in this invention, have inferior dimensional stability. In addition, the PVC boards could not exhibit a wood-like surface quality.

Notwithstanding the products and processes previously disclosed in the prior art, there remains a need for a strong synthetic wood boards, which have low density, smooth surface, stable dimension, strong abrasion resistance, excellent flammability resistance and long termed outdoor weather durability. A wood-thermoplastic composition for synthetic wood board and its process for production thereof are disclosed in this invention which is neither taught nor rendered obvious by the prior art.

### SUMMARY OF THE INVENTION

The present invention overcomes the disadvantages of the prior art by providing a method (process) for producing synthetic wood boards of low density, stable dimension, wood-like surface quality, good flammability resistance and outdoor weather durability.

The sheet forming composition used in the present method invention contains from about 70 to about 100 parts by weight (hereinafter referred to as PBW) of vinyl chloride resin, about 10 to about 100 PBW of wood or cellulose component and about 0.5 to about 10 PBW of foaming agents. Other additives such as heat stabilizers, processing aids, colorants, lubricants, fillers, flame retardants and ultraviolet light inhibitors may be included in the composition without departing from the scope of this invention.

In the present invention method, the composition is initially mixed in a mixing system, which contains a series of mixing steps to ensure the complete mixing of the component materials and additives. The mixture is then transferred to an extruder to be plastified and extruded through a die assembly to form sheets.

In one of the embodiments, the surface of the hot thermoplastic mass is immediately quenched by calibrator assembly after passing through the die assembly to form solid skins and foamed core. The boards produced from this embodiment have smooth surface, good surface abrasive resistance with surface hardness in the range of about 55 to about 70 as measured by Type D durometer and low density of about 0.45 to about 0.95 g/cm3. The thickness of the synthetic wood boards of this embodiment is preferably above about 5 mm.

In the other embodiments, the extruded web is rolled between rollers and is slowly cooled on a plurality of supporting rollers to have uniform foaming of the entire thickness of the boards. The synthetic wood board of this embodiment has an embossed surface texture and a low density in the range of about 0.5 to about 1.0 g/cm3. The thickness of the synthetic wood boards of this embodiment can be as thin as 1 mm and preferably below about 19 mm thick.

The synthetic wood board produced from the sheet forming composition used in the production process of this invention is shown to have much less shrinkage when being cured in an oven of 110 degrees Celsius for 30 minutes as compared to regular foamed boards containing only inorganic filler in the forming composition. A 19 mm synthetic wood board has a shrinkage percentage of from about −3.0% to about +1.0% as compared to regular PVC foamed boards of from about −4.0% to about −7.0%. It is believed that PVC and wood component, which performs as organic filler, has strong affinity compared to PVC and inorganic filler, such as calcium carbonate. Besides, the mixing, plastifying and extruding processes of this invention further help to enhance the affinity effect to improve the dimensional stability of the synthetic foamed wood boards. This result is unexpected and is neither taught nor rendered obvious by the prior art.

### BRIEF DESCRIPTION OF THE DRAWINGS

The features of the present invention, which are believed to be novel, are set forth with particularity in the appended claims. The invention may best be understood by reference to the following description taken in conjunction with accompanying drawings, wherein like reference numerals identify like elements and wherein:

FIGS. 1a and 1b are flow charts which show the main production steps of the two embodiments of the present invention method;

FIG. 2 is a schematic drawing of the production method of the present invention used to produce hard skin synthetic wood boards, which contains an extruder and die assembly, a calibrator, a cooling bath, a haul-off unit and a slitter or guillotine.

FIG. 3 is a schematic drawing of the cooling roller unit, roller stack and support rollers in one of the embodiments of the present invention method used to produce synthetic wood boards of embossed surface.

### DETAILED DESCRIPTION OF THE PRESENT INVENTION

Composition and Materials Used in the Invention

The composition of the wood-like thermoplastic PVC boards of this invention comprises: (1) about 70 to about 100 PBW of polyvinyl chloride, (2) about 10 to about 100 PBW of wood or cellulose components and (3) about 0.5 to about 10 PBW of foaming agents that decomposed at elevated temperature. In addition, other additives such as heat stabilizers, processing aids, colorants, lubricants, fillers, flame retardants and ultraviolet light inhibitors may be included in the composition without departing from the scope of this invention.

These other additives may be included in total in amounts of about 0.1 PBW to about 100 PBW. Heat stabilizers may be included in amounts of about 0.1 PBW to about 5 PBW. Processing aids may be included in amounts of about 0.1 PBW to about 30 PEW. Colorants may be included in amounts of about 0 PBW to about 8 PBW. Lubricants may be included in amounts of 0.1 PBW to about 5 PEW. Fillers may be included in amounts of about 0 PBW to about 20 PBW. Flame retardants may be included in amounts of about 0 PBW to about 30 PBW. Ultraviolet light inhibitors may be included in amounts of 0 PBW to about 3 PBW.

The vinyl chloride based resin used in the present invention is either a homopolymer of vinyl chloride, or a copolymer of vinyl chloride and a monomer polymerizable with vinyl chloride. Any vinyl chloride resin or copolymer may be used, which is made of suspension polymerization, mass polymerization or emulsion polymerization. A monomer, which is polymerizable with vinyl chloride, may be used, selected from the group consisting of vinyldiene chloride, vinyl acetate, maleic acid, methacrylate ester, acrylonitrile, methacrylonitrile, styrene, ethylene, propylene and the like. A mixture of polyvinyl chloride with at least one type of blending resin, such as chlorinated polyvinyl chloride, chlorinated polyethylene and ethylene vinyl acetate copolymer are within the scope of this invention.

When mixtures of resins are included, a ratio of about 100:0 up to about 50:50 of vinyl chloride to other resins may be used.

Nonetheless, it is most desirable that a homopolymer of vinyl chloride be used since this polymer is inexpensive, heat resistant and sufficiently incombustible. The inherent viscosity of the PVC as measured according to ASTM D-1243 is preferably in the range of about 0.6 to about 1.5. A commonly used additive or additives, such as PVC stabilizers, may be added to the vinyl chloride resin. In addition, recycled PVC (“reclaim”) such as post-consumer and industrial material may also be included.

The potential sources for the wood component are extremely varied. Sources include but are not limited to sawdust available from furniture or pallet manufacturers. Another source of wood component could be wood chips from a lumberyard or paper manufacturing facility. Both hardwood and softwood sources are acceptable. The wood component first undergoes a size reduction step that renders the wood component to particles that pass through a size 30 mesh or smaller sieve. The present invention contemplates but is not limited to the wood component having a bulk density of about 0.08 to about 0.4 g/cm3.

Wood fiber is hygroscopic and tends to pick up moisture. Excessive moisture in the wood fiber material will cause bubbling or pitting in the finished sheet. Thus, whatever the identification of the wood component is, it is important to reduce the moisture content to a level which will avoid the problems of bubbling or pitting in the final products. Any conventional equipment may be used as long as the function of effectively reducing the moisture content of the wood component is accomplished. The objective is to reduce moisture content of the wood component to less than about 80% by weight. After the wood component is properly dried, the wood component is then conveyed to a weigh system and fed to the mixer.

Any commonly used organic or inorganic foaming agent that decomposes when heated can be used in this invention. The organic foaming agents, which can be used in this invention are azodicarbonamide, N,N′-dinitrosopentamethylene tetramine, N,N′-dinitroso-N-N′-dimethyl terephthal amide, benzene sulfonyl hydazide, benzene-1,3-disulfohydrazide, therphthalic azide and the like. The inorganic foaming agents, which can be used in the present invention, are sodium bicarbonate, ammonium chloride and the like. The foaming agents, either organic or inorganic, can be used alone or in combination with other foaming agents in the present invention.

It is needless to say that, in the invention, ingredients, which are usually used as additives of PVC, can be appropriately employed if necessary. These ingredients include heat stabilizers, such as organotin stabilizers, epoxidized soybean oils, etc., lubricants, such as calcium stearate, polyethylene wax, etc., processing aids, such as copolymers of methylmethacrylate and akylacrylates, etc., and fillers such as calcium carbonate, talc, etc. In addition, ultraviolet light inhibitors such as hindered amine light stabilizers, smoke suppressants such as molybdenum oxide and flame retardants such as antimony trioxide, zinc borate, aluminum trihydrate, etc. may be incorporated in the above composition to enhance the specific properties of the present invention according to the application requirement of wood thermoplastic sheets.

### Mixing of Components and Extruding Sheets

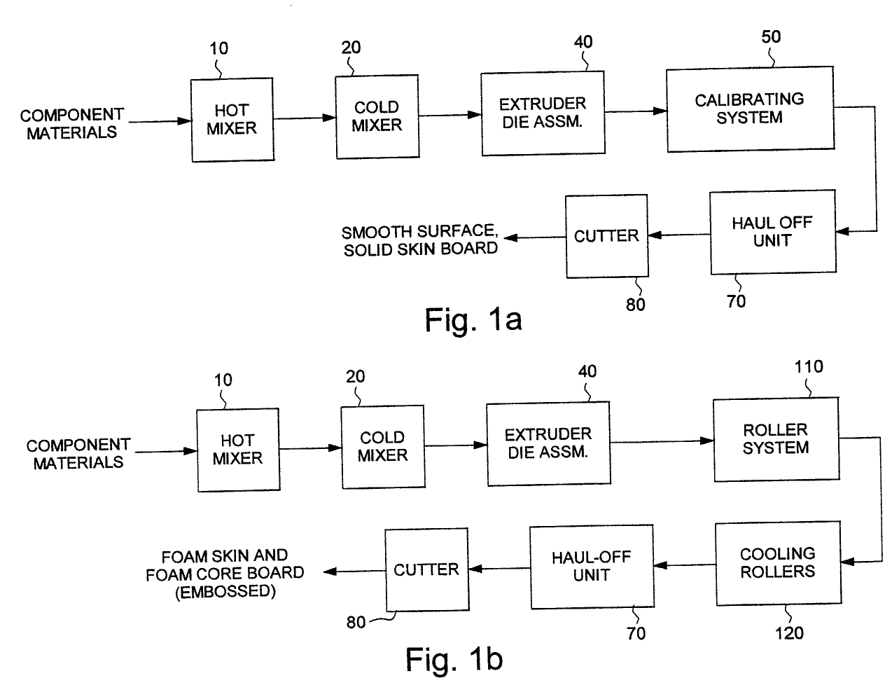

The production process of this invention is shown schematically in FIGS. 1a and 1b in separate flow charts wherein identical elements are identically numbered. Referring to FIG. 1a, there is shown a hot mixer 10, a cold mixer, an extruder and a die assembly 40, a calibrating system 50, a haul-off unit 70 and a slitter or guillotine 80. FIG. 1a illustrates the flow of the production process which produces the wood-thermoplastic boards of low density, stable dimension, smooth surface, strong abrasion resistance, excellent flammability resistance and long term outdoor stability. According to another embodiment, shown in FIG. 1b, the calibrating system 50 is substituted with a roller system 110 and a plurality of support rollers shown as cooling rollers 120 to produce foamed synthetic wood sheeting of embossed surface and thin gauge (less than 19 mm).

Referring to both FIGS. 1a and 1b, component materials of suitable proportions are charged into a high intensity hot mixer 10, which completely mixes the vinyl chloride resin, wood component, foaming agent and other additives. In the central portion of the bottom surface of the mixer container is an impeller, which rotates at a high speed in a horizontal direction by a rotating means such as a motor. Though no external heating is involved, the mixtures inside the mixer 10 tend to become warmer due to the heat generated from the friction of the impeller and the materials in the mixer. Normally, external cooling is not required but temperatures above the fusion temperature of PVC is avoided. The impeller rotates at a high speed of about 300 to about 1500 rpm.

In the hot mixer 10, the particles are driven, under high shearing forces, apart and also into one another. All the ingredients are literally driven into the particle of resin or uniformly dispersed. This prepares a dry blend in a uniform, dry easy-flowing condition for eventual feed to extruder 40. The temperature of the mixture in the hot mixer 10 tends to increase continuously. The mixtures are discharged to the cold mixer 20 when the temperature of the mixture is raised to a preset temperature of about 80 to about 140 degrees Celsius. The mixture is cooled to about 25 to about 60 degrees Celsius while being agitated in the cold mixer 20. If a dry blend is dropped from a hot mixer without agitated cooling, two problems would result. First, the dry blend would form clumps or agglomerates when it slowly cooled to ambient temperature. Second, PVC degradation would occur. The PVC and wood mixtures are relatively good insulators. Thus the heat of the blend would be retained for a long time near the center of the storage container, causing polymer degradation.

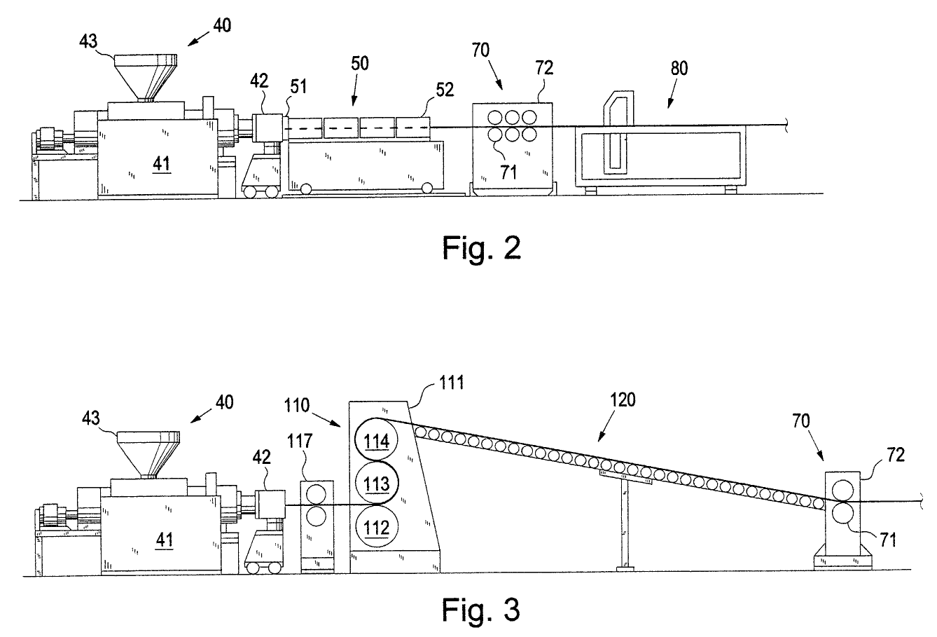

Referring now to FIGS. 1a, 1b, 2 and 3, as to expand upon the details of the elements shown in FIGS. 1a and 1b, and wherein identical elements are identically numbered, the mixture is next transferred from the cold mixer 20 to the extruder die assembly 40 and specifically to the extruder hopper 43 (FIGS. 2 and 3) through a feeding system, which has augers inside plastic tubes.

Suitable apparatus means for the plastifying and extruding steps are known in the art of extruding thermoplastic polymers. Generally, the plastifying and extruding steps can be carried out in a single apparatus, such as a screw extruder 41, preferably a contra-rotating twin screw extruder.

Referring now specifically to FIG. 2, the wood-thermoplastic mixture is introduced into the hopper of the extruder, plastified within the extruder cavity at a temperature above the fusion temperature of the thermoplastic polymer component, preferably in the range of about 140 to about 225 degrees Celsius. The plastified and melted thermoplastic mass is then extruded through a die head and die lip assembly 42 at the end of the extruder 41 to form sheeting.

According to an advantageous embodiment shown schematically in FIG. 2, the foamed synthetic wood board is next quenched by a pre-calibrator 51, of calibrating system 50, which intimately attaches to die assembly 42, to set the thickness of the sheeting. Pre-calibrator 51 is cooled by a cooling medium to control the temperature in the range from about 15 to about 60 degrees Celsius. The pre-calibrator 51 is immediately followed by a smooth calibrator 52, whose gap is greater or equal to the gap of pre-calibrator 51. Calibrator 52 is cooled by a low-temperature fluid circulates inside a casing. The preferred fluid is chilling water and the temperature of the calibrator is preferably from about 5 to about 60 degrees Celsius.

When the thermoplastic mass exits the die, the high pressure exerted on the thermoplastic mass inside the die is abruptly released. The gases, which are generated from the decomposition of the foaming agents in the extruder and are dissolved in the thermoplastic mass due to the high pressure inside the extruder, start to phase-separate from the thermoplastic mass to form bubbles. Since the skins of the PVC and wood composite are quenched and solidified immediately after exiting the die, the gas dissolved in the thermoplastic mass does not have time to separate from the thermoplastic mass to form bubbles, therefore smooth and solid skins are formed. The temperature of the thermoplastic mass beneath the skins (the core) decreases slowly because PVC itself is a poor heat conductor so the heat removal in the core is slow. Before the temperature in the core drops below the solidification temperature, the gas in the thermoplastic mass phase separate from the thermoplastic mass and form bubbles inside the core to reduce the density of the wood-thermoplastic PVC boards.

In any invent, using this device, a perfectly calibrated wood-thermoplastic PVC board having an impeccable wood-like surface quality, strong surface abrasive resistance, dimensional stability and a low density is obtained. However, if we are seeking a surface of embossed quality or if we are seeking wood-thermoplastic PVC boards of thin gauge (less than 13 mm), the thermoplastic mass pass through the die head and die lip assembly can be rolled and cooled to form the wood-thermoplastic boards.

A suitable means for rolling and cooling the web is shown in FIG. 3. (Again, identical elements shown in FIGS. 1a, 1b, and 2 above, are identical and need not be rediscussed here.) FIG. 3 includes cooling roller unit 117, a roller frame 111 supporting three contra-rotating rollers 112, 113 and 114, a plurality of support rollers 120. In operation, the hot thermoplastic mass extruded from the slot die of the extruder enters the cooling roller unit 117, which is controlled at temperature in the range of about 5 to about 30 degrees Celsius. The cooling roller unit 117 contains from zero to three sets of two rollers of diameter in the range of from about 50 to about 150 mm, which briefly cool the top and bottom of the web. The web is then introduced into the nip between rollers 112 and 113 and through the nip between rollers 113 and 114. Optionally, the thermoplastic mass can be introduced into the nip between rollers 114 and 113, guided around roller 113 and through the nip between rollers 113 and 112. The temperatures of rollers 112, 113 and 114 are controlled in the range of about 25 to about 250 degrees Celsius. The web is then led to support rollers 120. The web will be allowed to cool and solidify, generally under ambient temperature. If desired, cooling may be intensified by blowers.

As previously explained, the gas dissolved in the thermoplastic mass starts to phase separate after exiting the slot die. In this embodiment, the surface temperature of the thermoplastic mass is slowly cooled. Therefore, bubbles form both in the core and the skins of the web. Some of the bubbles migrate to the surface and burst to form an embossed texture on the surfaces of the web before the sheeting is solidified. Most of the bubbles trap inside the sheeting when the thermoplastic mass is cooled and solidified. Using this process, sheeting having embossed texture, light weight and stable dimension is obtained. The embossed texture of the surfaces of the boards can be further enhanced with one or combination of rollers 112, 113 and 114 of pattern-embossed surfaces. The enhancement of the surface texture can be one or both sides of the PVC wood-like boards.

The cooling strength of the cooling roller unit 117 reduces the bubble formation in the skin layers while not entirely blocking the bubble formation in the top and bottom skin layers. A strong cooling system like the calibrating system 50 can not generate an embossed pattern since bubble formation in the skin layers is completely obstructed. However, lacking the cooling roller unit, too may bubbles formed in the skin layers reduce the surface hardness. When compared with embossed synthetic boards produced from the process without the cooling roller unit 117, the process of this embodiment improves the shore hardness of the thermoplastic board from about 50 to about 60 D-scale as measured according to ASTM 2240.

Counter-rotating draw-off rollers 71 supported by frame 72 causes the extruded sheets to be carried away from calibrator 50 or roller system 110 and support rollers 120. After that, the synthetic wood board is cut at desired length by cutting machines 80 such as slitter, guillotine, saw or the like. If the foamed synthetic wood board is thin, a cutting machine 80 such as a guillotine is used, while if the sheeting is thick, for example, thicker than about 6 mm, a cutting machine such as a slitter, saw or the like is used.

### Properties of PVC Resin and Sheets

The properties of the thermoplastic resin and the synthetic wood board produced by the present invention, described in conjunction with the examples below, were determined by the following methods.

Intrinsic Viscosity: ASTM D 1243—PVC is dissolved in cyclohexanone to make a solution of specified concentration. Inherent viscosity is calculated from the measured flow rate of the solvent and of the polymer solution at 30 degrees Celsius.

Density: ASTM D 792—A piece of the thermoplastic product is weighed in air. It is then immersed in water at 23 degrees Celsius, its loss in weight upon immersion is determined, and its density calculated.

Heat Shrinkage at 110 degrees Celsius: The length and width of thermoplastic boards are measured at 23 degrees Celsius. The board is then moved to the oven controlled at 110 degrees Celsius and stayed for 30 minutes. Cool the board back to room temperature. The length and width changes are determined and the shrinkage percentages are calculated.

Shore Hardness: ASTM D 2240—This method permits hardness measurements based on initial indentation of the material at 23 degrees Celsius. Type D durometer is used.

The following examples are given in illustration of this invention and are not intended as limitation thereof.

### EXAMPLES

The present invention will now be explained by the following examples. The following examples are illustrative of the present invention and are not included as a limitation of the scope thereof.

### Example 1

(1) Compositions

In the Example, homopolymer vinyl chloride resin, which has an inherent viscosity of 0.91, and soft wood fiber, which has a particle size smaller than 425 microns (40 Mesh), a bulk density of about 0.11 g/cm3 and a moisture content less than 8%, are used. The foaming agent package is a combination of sodium bicarbonate and azodicarbonamide. The proportions of the above components and other additives are:

| | |
|---|---|
| Homopolymer PVC | 90.3 PBW |
| Wood Fiber | 40.0 PBW |
| Foaming Agent Package | 8.8 PBW |
| Heat Stabilizer | 4.7 PBW |
| Lubricant Package | 7.0 PBW |
| Processing Aid Package | 18.0 PBW |
| Filler | 10.0 PBW |
| Reclaim | 20.0 PBW |

(2) Process

The above compositions is mixed in a hot mixer 10 and discharged to a cold mixer 20 when the temperature in the hot mixer 10 achieves 115 degrees Celsius. The cold mixer 20 is maintained at 45 degrees Celsius and the content is discharged to the storage tank after having received three hot batches. The mixture is then transferred to the extruder 40. The mixture is plastified and extruded by a twin screw extruder at about 155 to about 180 degrees Celsius and is shaped into a sheet form by the die assembly 41 at about 140 to about 185 degrees Celsius. The sheeting is then quenched by a pre-calibrator controlled at about 32 to about 36 degrees Celsius and a calibrator 50 at about 15 degrees Celsius.

(3) Properties of the Board

Boards obtained from the above composition and process have a wood-like surface and hard skins. The physical properties are as follows:

| | |
|---|---|
| Thickness (mm): | 19 |
| Density (g/cm3): | 0.66 |
| Hardness, Shore D: | 62 |

Shrinkage at 110 Degrees C., %: MD=+0.61

### Example 2

(1) Compositions

The component materials are the same as those in Example 1. The proportion of each component is also similar to the composition set forth in Example 1 except for removal of the wood fiber and minor adjustments of the additive packages to accommodate the wood fiber removal.

| | |
|---|---|
| Homopolymer PVC | 80.7 PBW |
| Foaming Agent Package | 7.8 PBW |
| Heat Stabilizer | 4.3 PBW |
| Lubricant Package | 5.9 PBW |
| Processing Aid Package | 16.0 PBW |
| Filler | 15.0 PBW |
| Reclaim | 20.0 PBW |

(2) Process

The production steps are the same as shown in Example 1. The process conditions are similar to those set forth in Example 1. Minor adjustments are needed to accommodate the formulation change.

(3) Properties of the Boards

The physical properties are as follows:

| | |
|---|---|
| Thickness (mm): | 19 |
| Density (g/cm3): | 0.54 |
| Hardness, Shore D: | 65 |

Shrinkage at 110 Degrees C., %: MD=−6

It was observed from the comparison of Examples 1 and 2 that the addition of wood fibers provides not only the wood-like surface but also improves the dimensional stability (shrinkage percentage) of the boards.

Obviously, numerous modifications and variations of the present invention are possible in light of the above teachings. It is therefore understood that within the scope of the appended claims, the invention may be practiced other than as specifically described herein.

What is claimed is:

1. A method of making synthetic wood-like products of low density, stable dimension, wood-like surface quality, good flammability resistance and outdoor weather durability, which comprises:
A.) forming a mixture containing:
(a) about 70 to about 100 parts by weight of vinyl chloride resin;
(b) about 10 to about 100 parts by weight of a natural cellulosic product;
(c) about 0.5 to about 10 parts by weight of vinyl chloride resin foaming agent;
B.) mixing the aforesaid mixture in a hot mixer with frictionally induced heating to temperatures of at least about 80 degrees Celsius and below the fusion temperature of polyvinyl chloride;
C.) subsequently mixing the mixture from in hot mixer in a cold mixer while cooling said mixture to a temperature of about 25 degrees Celcius to about 60 degrees Celsius;
D.) plastify and extruding the mixture through a plastifying and extruding means; and
E.) cooling extruded product to create a synthetic wood-like product.

2. The method of claim 1 wherein said mixture further includes:
(d) about 0.1 to about 100 parts by weight of additives selected from the group consisting of heat stabilizers, processing aids, colorants, lubricants, fillers, flame retardants, ultraviolet light inhibitors, and mixtures thereof.

3. The method of claim 1 wherein said plastifying and extruding are performed in an extruder.

4. The method of claim 1 wherein said mixing in a hot mixer is performed to a temperature in the ranges of about 80 degrees Celsius to about 140 degrees Celsius.

5. The method of claim 1 wherein the extruded product is cooled in a calibrating system rapidly to quench the extruded product so as to form a solid skin, foam core synthetic wood-like product.

6. The method of claim 5 wherein said calibrating system includes a precalibrator having a predetermined first thickness setting, and a subsequent calibrator which has a predetermined second thickness setting not less than said predetermined first thickness setting.

7. The method of claim 6 wherein said calibrator is fluid cooled so as to cool the extruded product to a temperature range of about 5 to about 60 degrees Celsius.

8. The method of claim 1 wherein said extruded product is cooled slowly so as to form a foam skin/foam core synthetic wood product.

9. The method of claim 8 wherein said cooling is performed in a roller system of a plurality of contra-rotating rollers.

10. The method of claim 9 wherein said cooling is further performed on a plurality of support rollers after said plurality of contra-rollers.

11. The synthetic wood-like product resulting from the method of claim 1.

12. The synthetic wood-like product resulting from the method of claim 2.

13. The synthetic wood-like product resulting from the method of claim 3.

14. The synthetic wood-like product resulting from the method of claim 4.

15. The synthetic wood-like product resulting from the method of claim 5.

16. The synthetic wood-like product resulting from the method of claim 6.

17. The synthetic wood-like product resulting from the method of claim 7.

18. The synthetic wood-like product resulting from the method of claim 8.

19. The synthetic wood-like product resulting from the method of claim 9.

20. The synthetic wood-like product resulting from the method of claim 10.
